(19) United States
(12) Patent Application Publication
(10) Pub. No.: US 2017/0150129 A1
(43) Pub. Date: May 25, 2017

(54) Dimensioning Apparatus and Method

(71) Applicant: CHICAGO MEASUREMENT, L.L.C., VOLO, IL (US)

(72) Inventor: JOHN GREGORY PANGRAZIO, VOLO, IL (US)

(73) Assignee: CHICAGO MEASUREMENT, L.L.C., VOLO, IL (US)

(21) Appl. No.: 15/332,128

(22) Filed: Oct. 24, 2016

Related U.S. Application Data
(60) Provisional application No. 62/258,623, filed on Nov. 23, 2015.

(51) Int. Cl. H04N 13/02; G06T 7/60; H04N 13/00

(52) U.S. Cl. CPC H04N 13/0282; H04N 13/004; G06T 7/602; H04N 13/0296; H04N 13/0246; G06T 2207/10028; G06T 2207/20221; G06T 2207/30164

(57) ABSTRACT

An apparatus and method enable a workpiece carried on a transportation device to be dimensioned. The apparatus includes a plurality of camera pairs that are situated about a detection zone, and each of the camera pairs simultaneously capture an image of the workpiece. For each camera pair, the images are subjected to a reconciliation operation to obtain a point cloud that includes a plurality of points in three dimensional space from the perspective of that camera pair. The points represent points on the surface of the workpiece or the transportation device or another surface. The point clouds are transformed into transformed points in three dimensional space from the perspective of a pre-established origin of the dimensioning apparatus. The transformed points are combined together to obtain a combined point cloud that is used to generate a characterization of the workpiece from which the dimensions of the workpiece can be obtained.

### CROSS-REFERENCE TO RELATED APPLICATION

The instant application claims priority from U.S. Provisional Patent Application Ser. No. 62/258,623 filed Nov. 23, 2015, the disclosures of which are incorporated herein by reference.

### BACKGROUND

Technical Field

The disclosed and claimed concept relates generally to the dimensioning of articles and, more particularly, to a method and apparatus for dimensioning a workpiece that is carried on a transportation device.

Related Art

Shipping costs are typically determined based on various measurements of an object being shipped (hereinafter, the “workpiece”). Weight, as is well known, is based upon the mass of a workpiece and can be determined with the use of a scale. Shipping costs can also be affected by the physical dimensions of a workpiece. The expression “dimensional weight” thus relates to a characterization of a workpiece in a fashion that can encompass aspects of both the weight and the physical dimensions of the workpiece or at least an aspect of the more significant of the two. The dimensional weight of a workpiece can be based upon a load as disposed on a pallet. Such a pallet may, and often does, support more than one object. Thus, even if several generally rectangular objects are stacked on a pallet, the resulting workpiece may have a non-rectangular shape.

It is understood that a dimensional weight is a characterization of a workpiece. That is, the workpiece may have an unusual shape or may include several rectangular boxes which are stacked so as to be an unusual shape. While it may be possible to determine the exact volume of such a workpiece, a dimensional weight calculation potentially may “square out” the size of the workpiece. That is, as the workpiece, typically, cannot be made smaller than the greatest length in, or parallel to, any given plane defined by two of three axes, the dimensional weight calculation may take into account the volume of the workpiece as determined by the maximum length along, or parallel to, one or more of the X-axis, the Y-axis, and the Z-axis.

This volume is then divided by a standard unit (166 in.³/lb. (international) or 192 in.³/lb. (domestic)) to achieve a dimensional weight. For example, if a workpiece is measured to be six feet (72 inches) by four feet (48 inches) by three feet (36 inches), the dimensional weight would be calculated as follows: First the volume is calculated as: 72 in.*48 in.*36 in.=124,416 in.³. The volume is then divided by the standard unit, in this example the domestic standard unit: 124,416 in.³÷192 in.³/lb.=648 lbs. Thus, the dimensional weight is 648 pounds. The shipping cost would then be determined by using the greater of the dimensional weight or the actual physical weight, as measured by a scale. So, if the workpiece was an iron ingot weighing 2,000 pounds, the actual weight would be used to determine the shipping cost. Alternatively, if the workpiece was a carton of feather pillows weighing 200 pounds, the dimensional weight would be used to determine the shipping cost.

The determination of a dimensional weight is typically performed at a stationary device/station into which a workpiece must be placed. The dimensional weight has typically been determined by a system using time-of-flight data, i.e. providing a wave (either sound or electromagnetic) and measuring the time it takes for the wave to reflect from the workpiece. Such time-of-flight devices typically use a plurality of transducers that must be maintained and kept properly oriented. Such time-of-flight transducers may be expensive to purchase, install, calibrate, and/or maintain. Other systems utilize a plurality of light projection devices, typically lasers, and multiple cameras to create, or emulate, a three-dimensional perspective. Such systems may be disposed in a tunnel or similar construct through which a forklift truck or other transportation device passes while carrying the workpiece. Similar but smaller systems may be disposed about a conveyor belt that transports workpieces.

At a shipping facility, the dimensional weight of a workpiece may be determined as the workpiece is disposed upon a pallet. A forklift truck or similar device may move the pallet into/onto/through a device structured to determine the dimensional weight. If the device is a station, the pallet is typically driven to the location of the station, after which the dimensional weight is determined, and the pallet and workpiece are moved on for further processing. If the system utilizes a tunnel, the forklift truck drives the workpiece to the location of the tunnel and then drives at a relatively slow pace through the tunnel to ensure the multiple cameras/lasers acquire the necessary data.

Thus, a number of shortcomings are associated with known systems for assessing the dimensions or dimensional weight or both of a workpiece. First, known dimensional weight systems can be expensive to build and maintain. Second, the processing of a workpiece at a shipping facility may be slowed by the required steps of transporting the workpiece to, and positioning the workpiece in, or slowly through, the dimensional weight device. Third, such systems have typically had limited success in accurately determining the dimensions of a workpiece due to limitations of camera angle and placement that often result in the camera seeing only a limited view of the workpiece. Improvements thus would be desirable.

### SUMMARY

Advantageously, therefore, an improved apparatus and method enable a workpiece that is carried on a transportation device to be dimensioned. The apparatus includes a plurality of camera pairs that are situated about a detection zone, and each of the camera pairs simultaneously capture an image of the workpiece. For each camera pair, the images are subjected to a reconciliation operation to obtain a point cloud that includes a plurality of points in three dimensional space from the perspective of that camera pair. The points represent points on the surface of the workpiece or the transportation device or another surface. The point cloud of each of one or more of the camera pairs are then transformed into a plurality of transformed points in three dimensional space from the perspective of a pre-established origin of the dimensioning apparatus. The various transformed point clouds are combined together to obtain a combined point cloud that is used to generate a characterization of the workpiece from which the dimensions of the workpiece can be obtained.

Accordingly, an aspect of the disclosed and claimed concept is to provide an improved dimensioning apparatus that includes a plurality of camera pairs, wherein the cameras of each camera pair are situated such that their operational directions are oriented generally parallel with one another, and wherein each camera pair is directed from a different direction generally toward a detection zone of the dimensioning apparatus.

Another aspect of the disclosed and claimed concept is to provide such a dimensioning apparatus that employs the plurality of camera pairs to simultaneously capture images of a workpiece from a plurality of different perspectives about the workpiece, with such images resulting in point clouds that are combinable in order to result in a combined point cloud that includes data from different directions about the workpiece.

Another aspect of the disclosed and claimed concept is to provide an improved method of employing such a dimensioning apparatus to generate a characterization of a workpiece from which the dimensions of the workpiece can be obtained.

Another aspect of the disclosed and claimed concept is to provide an improved method and apparatus that enable more accurate characterizations of a workpiece that is carried on a transportation device.

Another aspect of the disclosed and claimed concept is to provide an improved method and apparatus that enable more rapid characterization of a workpiece that is carried on a transportation device by avoiding the need for the transportation device to stop when a plurality of images of the workpiece are simultaneously captured.

Another aspect of the disclosed and claimed concept is to provide an improved dimensioning apparatus and method of use wherein the components of the dimensioning apparatus need not be of the most robust construction since they are not carried on a transportation device such as a forklift truck or the like and thus do not physically interact with the equipment or the workpieces that are prevalent in a warehousing or shipping operation.

Accordingly, an aspect of the disclosed and claimed concept is to provide an improved method of employing a dimensioning apparatus to generate a characterization of a workpiece that is carried on a transportation device and that is situated in a detection zone of the dimensioning apparatus. The dimensioning apparatus can be generally stated as including a plurality of detection devices. The method can be generally stated as including substantially simultaneously capturing a representation of the workpiece with each of the plurality of detection devices, for each detection device, employing the representation therefrom to obtain a point cloud that comprises a plurality of points in three-dimensional space from the perspective of the detection device, transforming the point cloud of at least one detection device into a transformed point cloud that comprises a plurality of transformed points in three-dimensional space from the perspective of a pre-established origin of the dimensioning apparatus that is different from the perspective of the at least one detection device, combining together the transformed point cloud and another point cloud from another detection device that comprises another plurality of points in three-dimensional space from the perspective of the pre-established origin to obtain a combined point cloud, the at least one detection device being different from the another detection device, and employing the combined point cloud to generate the characterization.

Another aspect of the disclosed and claimed concept it to provide an improved dimensioning apparatus having a detection zone and being structured to generate a characterization of a workpiece that is carried on a transportation device within the detection zone. The dimensioning apparatus can be generally stated as including a plurality of detection devices each having an operational direction that is oriented generally toward the detection zone, and a computer system that can be generally stated as including a processor and a storage. The computer system can be generally stated as further including a number of routines that are stored in the storage and that are executable on the processor to cause the dimensioning apparatus to perform operations that can be generally stated as including substantially simultaneously capturing a representation of the workpiece with each of the plurality of detection devices, for each detection device, employing the representation therefrom to obtain a point cloud that comprises a plurality of points in three-dimensional space from the perspective of the detection device, transforming the point cloud of at least one detection device into a transformed point cloud that comprises a plurality of transformed points in three-dimensional space from the perspective of a pre-established origin of the dimensioning apparatus that is different from the perspective of the at least one detection device, combining together the transformed point cloud and another point cloud from another detection device that comprises another plurality of points in three-dimensional space from the perspective of the pre-established origin to obtain a combined point cloud, the at least one detection device being different from the another detection device, and employing the combined point cloud to generate the characterization.

### BRIEF DESCRIPTION OF THE DRAWINGS

A further understanding of the disclosed and claimed concept can be gained from the following Description when viewed in conjunction with the accompanying drawings in which:

FIG. 1 is a schematic depiction of an improved dimensioning apparatus in accordance with the disclosed and claimed concept;

FIG. 2 is a depiction of a camera pair of dimensioning apparatus of FIG. 1;

FIG. 3 depicts a pair of images of a workpiece situated on a forklift truck that are captured simultaneously by a camera pair of the dimensioning apparatus of FIG. 1;

FIG. 4 is a depiction of the forklift truck having a normal vector and a plane depicted thereon; and

FIG. 5 is a flowchart depicting certain aspects of an improved method in accordance with the disclosed and claimed concept.

Similar numerals refer to similar parts throughout the specification.

### DESCRIPTION

The disclosed and claimed concept, in general terms, relates to a dimensioning apparatus 4 and associated method that enable dimensioning of a workpiece 8 without the need to stop transportation device such as a forklift 16 or other vehicle during detection of the dimensions of the workpiece 8. This is accomplished through the use of a plurality of detection devices that are distributed about a detection zone 36. In the depicted exemplary embodiment, each such detection device includes a pair of sensing elements for reasons that will be set forth below. Each sensing element is in the exemplary form of camera, and thus the pair of sensing elements of each such detection device are together in the form of a stereoscopic camera pair. That is, the dimensioning system 4 includes a plurality of sensing elements in the exemplary form of cameras that are indicated at the numerals 44 and 46 and which are arranged in a plurality of camera pairs 40A, 40B, 40C, 40D, 40E, 40F, 40G, and 40H (which may be individually or collectively referred to herein with the numeral 40). Each camera pair 40 is a detection device which includes a pair of sensing elements in the form of one of the cameras 44 and one of the cameras 46. The cameras 44 and 46 in the depicted exemplary embodiment are identical to one another.

The dimensioning apparatus 4 further includes a computer system 10 with which camera pairs 40 are in wireless or wired communication. The computer system includes a processor 12 and a storage 14. The processor can be any of a wide variety of processors, such as a microprocessor or other processor. The storage can be any of a wide variety of storage media and may include, for example and without limitation, RAM, ROM, EPROM, EEPROM, FLASH and the like which functions as a storage system of a computing device. The computer system 10 further includes a number of routines 18 that are stored in the storage 14 and that are executable on the processor 12 to cause the computer system 10 and the dimensioning apparatus 4 to perform certain operations.

The vehicle 16 can be said to include a mast apparatus 24 that is situated on the chassis of the vehicle 16 and to further include a fork apparatus 20 that is situated on the mast apparatus 24. The mast apparatus 24 is operable to move the fork apparatus 20 along an approximately vertical direction in order to enable the fork apparatus 20 to pick up and lower the workpiece 8 as part of the operation of transporting the workpiece 8 from one location to another, such as during a warehousing or shipping operation. The mast apparatus 24 includes a pair of masts 28A and 28B (which may be individually or collectively referred to herein with the numeral 28) and further includes a rigid collar 32 that is affixed to the masts 28 and that extends therebetween at the upper ends thereof.

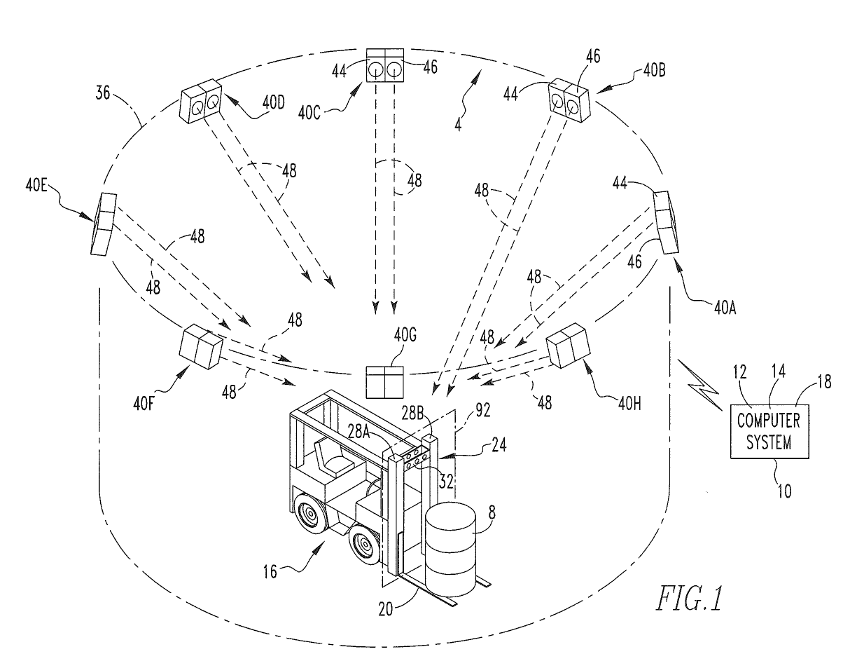

The plurality of camera pairs 40 are positioned about a circle perhaps 15 feet across and situated perhaps 15 feet off the floor to define the detection zone 36. The detection zone 36 can be of other shapes, sizes, etc., without limitation. The cameras 44 and 46 each have an operational direction 48, which can be characterized as being the direction with respect to the cameras 44 and 46 along which subject matter is photographically captured by the cameras 44 and 46. The cameras 44 and 46 of each camera pair 40 are directed generally into the detection zone 36, as is indicated in FIG. 1 by the operational directions 48 of the various cameras 44 and 46 that are depicted therein.

The forklift 16 approaches and enters the detection zone 36 without stopping during detection of the dimensions of the workpiece 8, although it typically is necessary for the forklift 16 to be moving at most at a maximum velocity of, for example, 15 miles per hour. This maximum velocity is selected based upon the optical properties and the image capture properties and other properties of the cameras 44 and 46. When the forklift 16 and its workpiece 8 are in the detection zone 36, all of the cameras 44 and 46 of each of the camera pairs 40 simultaneously take an image of the workpiece 8. The fact that the cameras 44 and 46 are each simultaneously rapidly taking a single image advantageously negates the fact that the workpiece 8 and the forklift 16 are actually in motion when the images are being recorded. The captured images each constitute a different representation of the workpiece 8 and, likely, at least a portion of the vehicle 16 and, perhaps, a number of features of the warehouse facility or other facility within which the detection zone 36 is situated. The expression “a number of” and variations thereof shall refer broadly to any non-zero quantity, including a quantity of one.

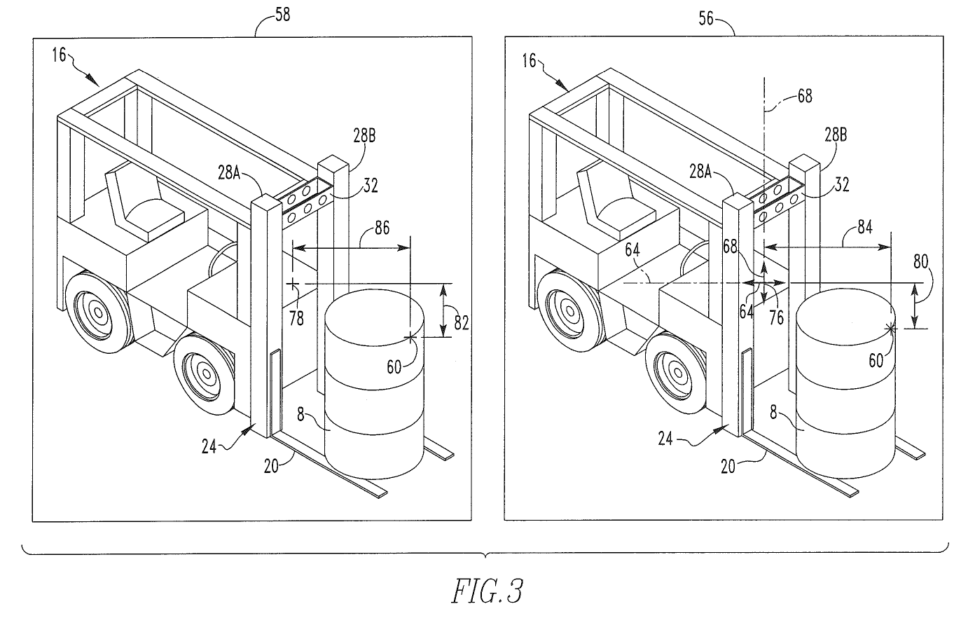

A pair of images 56 and 58 (such as are depicted generally in FIG. 3) are captured and recorded by the pair of cameras 44 and 46 of each camera pair 40. Each camera pair 40 captures and records a pair of images, such as the images 56 and 58. Each of the images are different from one another since they are each taken from a different perspective of the workpiece 8 and from a different location about the detection zone 36.

The pair of images 56 and 58 captured by any given camera pair 40 are then related to one another via a process known as rectification. The camera pair 40B will be used as an example. The two images 56 and 58 of the camera pair 40B, when rectified, result in a point cloud of points in three-dimensional space with respect to that camera pair 40B that represent points on the surfaces of the workpiece 8 or the forklift 16, etc. More specifically, the rectification operation results in at least some of the pixels in the image 56 from the camera 44 being identified and logically related to corresponding pixels in the image 58 from the other camera 46 of the camera pair 44B, or vice-versa.

By way of background, the cameras 44 and 46 of any given camera pair 40 in the depicted exemplary embodiment do not automatically perform rectification and rather must be associated with one another. The present concept involves taking a plurality of individual cameras and affixing them together in pairs so that their operational directions are as aligned with one another as is possible. The cameras 44 and 46 of each camera pair 40 can be either horizontally aligned with respect to one another (i.e., with the cameras 44 and 46 being situated side-by-side) or vertically aligned with respect to one another (i.e., with the cameras 44 and 46 being situated one atop the other), and horizontal alignment is used for the present example. While any given pair of cameras 44 and 46 may be physically situated as close to one another as possible, the sensors 52 and 54 of the cameras are still spaced apart from one another in the horizontal direction in the depicted example. While it is understood that the cameras 52 and 54 are digital cameras that typically have a CMOS or other type of sensor embedded therein, the front faces of the lenses of the cameras 44 and 46 are used herein as a representation of the sensors 52 and 54 since the light that is projected onto the front faces of the camera lenses is itself projected by the lenses onto the sensors 52 and 54 for capture thereby. As such, the subject matter that is projected onto the front faces of the camera lenses is represented by the images 56 and 58, for example, that are generated by the sensors 52 and 54 and that are thus captured and recorded.

Before any given camera pair 40 can be used to capture images as part of a dimensioning operation, the corresponding pair of cameras 44 and 46 of the camera pair 40 must first undergo a calibration procedure. Such calibration can be accomplished, for example, by using a calibration routine 18 in the exemplary form of a software application such as OpenCV wherein the cameras 44 and 46 become logically associated with one another. As will be set forth in greater detail below, the OpenCV software package also includes a rectification routine 18

The use of the OpenCV software in such a calibration process results in the generation and outputting of three matrices. The first matrix will be a correction matrix to make the camera 44 into a “perfect” camera (i.e., overcoming the limitations that may exist with the camera lens, the camera sensor, etc., thereof). The second matrix will create a “perfect” camera out of the camera 46 (i.e., overcoming whatever limitations may exists with the camera lens, the camera sensor, etc., thereof). The third matrix is a stereo rectification matrix that enables a pixel in one image from one camera 44 or 46 and another pixel in another image from the other camera 44 or 46 that is determined to correspond with the pixel in the one image to be assigned a distance coordinate in a direction away from the camera 44 or 46 that captured the one image. That is, the third matrix would enable pixels from an image captured by the camera 46 to be related via distance coordinates to corresponding pixels from an image captured by the camera 44. The calibration operation is typically performed only once for any given camera pair 40.

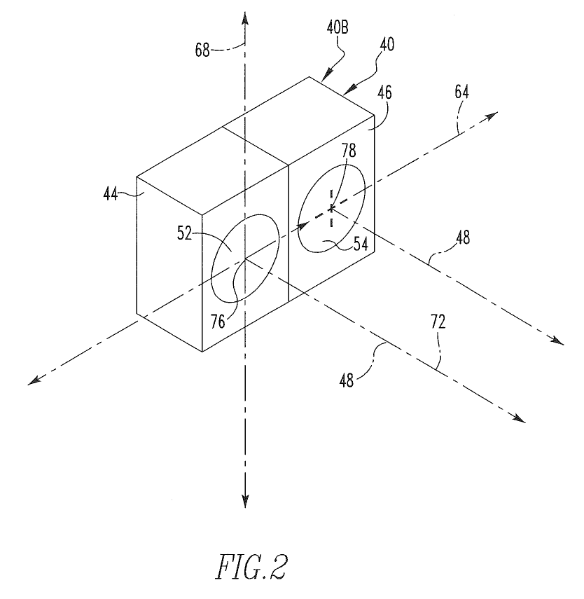

In use, and as will be set forth in greater detail below, each camera pair 40 simultaneously captures a pair of images of the workpiece 8 and the forklift 16, for instance, from which will be generated a point cloud that includes a plurality of points in three-dimensional space, with each such point having a set of coordinates along a set of coordinate axes that are defined with respect to the camera pair 40 that captured the pair of images. That is, and as is depicted in FIG. 2, an x-axis 64 is oriented in the horizontal side-to-side direction, a y-axis 68 is oriented in the vertical direction, and a z-axis 72 extends in the horizontal direction away from the camera pair 40. More specifically, the x-axis 64, the y-axis 68, and the z-axis 72 are mutually orthogonal, and they meet at an origin 76 which, in the depicted exemplary embodiment, is at the center on the front surface of the lens of the camera 44 of the camera pair 40.

In this regard, the cameras 44 and 46 can be referred to as being a master camera and an offset camera, respectively. That is, and for the sake of simplicity of explanation, the “master” image is considered to be the image 56 that is generated by the camera 44 of any given camera pair 40 (in the depicted exemplary embodiment), and the adjacent image 58 is that from the corresponding camera 46 of the same camera pair 40. The image 58 can be understood to be an offset image, i.e., offset from the image 56, that is used to give to a pixel in the master image 56 a coordinate along the z-axis 72. In other embodiments, the images 56 and 58 that are generated by the cameras 44 and 46 can be used to define a virtual camera that is situated between the cameras 44 and 46, with the images 56 and 58 each being offset in opposite directions from a (virtual) master image of such a virtual camera. These are two different ways explaining the same concept, and they are effectively interchangeable since the software employed by the computer system 10 does not rely upon such an explanation. The master/offset arrangement will be used herein for purposes of explanation and is not intended to be limiting.

The calibration procedure for any given camera pair 40 involves positioning the camera pair 40 with respect to the dimensioning zone 36, meaning orienting the cameras 44 and 46 thereof such that their operational directions 48 are pointing into the detection zone 36, and then taking a black and white checkerboard object and placing it in the field of view of the camera pair 40 at a plurality of positions and orientations to as great an extent as possible within the field of view of the two cameras 44 and 46. A calibration image is simultaneously captured by each of the cameras 44 and 46 for each of the plurality of positions and orientations of the black and white checkerboard object.

The calibration images are fed into calibration routine 18 of the OpenCV software program, or other appropriate routine 18, that is deployed on the computer system 10 of the dimensioning apparatus 4 and that is in its calibration mode. The dimensions of the checkerboard (number of squares in each dimension and the size of the squares themselves in each dimension) are also fed into the software program. The software program looks for the intersections between black and white areas. The software program then outputs the three aforementioned matrices, i.e., two being camera correction matrices, and the third matrix being the stereo rectification matrix. The two camera correction matrices are optional and need not necessarily be employed in the transformation operation, depending upon the needs of the particular application. After calibration, each camera pair 40 can be said to constitute a detection device having an operational direction 48, although it is noted that each of the cameras 44 and 46 of each of the camera pairs 40 is depicted herein as having its own operational direction 48 for purposes of explanation and simplicity of disclosure.

The OpenCV software application also has another mode, which can be referred to as a rectification mode, and this portion of the OpenCV software application can be referred to as a rectification routine 18. The OpenCV software in its rectification mode, i.e., the rectification routine 18, coverts captured pairs of images of the workpiece 8, for instance, captured simultaneously by a given camera pair 40, into a plurality of points in three-dimensional space, known as a point cloud. Each point in the point cloud has a set of coordinates along the x-axis 64, the y-axis 68, and the z-axis 72, and these coordinates represent distances along the x-axis 64, the y-axis 68, and the z-axis 72 from an origin 76 on the master camera 44 at which a certain location on the surface of the workpiece 8, for instance, that is represented by the point is situated.

During acquisition of the images 56 and 58 and measurement, i.e., generation of the point cloud, in the rectification mode of the OpenCV software application, the cameras 44 and 46 rely upon the identification of object pixels in the two images 56 and 58 of the pair. An object pixel is one whose intensity or brightness value is significantly different than that of an adjacent pixel. The cameras 44 and 46 are black and white and therefore do not see color, and rather the pixel intensity or brightness value is used to identify object pixels. The system might employ any of a wide variety of ways of identifying such a delta in brightness, such as perhaps normalizing all of the image intensity values to the lowest image intensity value and then looking at differences in the image intensity values between adjacent pixels that are at least of a predetermined magnitude, or simply finding the greatest magnitude of difference.

The system seeks to identify as many object pixels as possible in the two images 56 and 58, meaning all of the object pixels. The object pixels, such as an object pixel 60 in FIG. 3, is first identified in one image, i.e., the image 56 from the master camera 44, and the other image 58 is then searched to see if the same object pixel can be identified. Since the two cameras 44 and 46 of the pair 40 are oriented substantially parallel to one another and are looking at substantially the same thing, a significant likelihood exists that the adjacent camera 46 will be seeing roughly the same thing as the master camera 44, albeit offset by the horizontal distance between the sensors 52 and 54 of the two cameras 44 and 46. Since the two cameras 44 and 46 are horizontally spaced from one another and thus are at the same vertical location in space, a vertical location of the object pixel 60 on one of the two images 56 and 58 should be the same as the vertical location of the corresponding object pixel 60 on the other of the two images 56 and 58. That is, the only difference between the object pixel 60 in one image 56 and the same object pixel 60 in the other image 58 is a horizontal spacing between where the pixel appear in the one of the two images 56 and 58 compared with where it appears in the other of the two images 56 and 58.

It is expressly noted that while the cameras 44 and 46 of each camera pair 40 are oriented substantially parallel with one another, each camera pair 40 (i.e., each detection device) is oriented in a different direction into the detection zone 36. That is, the camera pair 40A is oriented in one direction toward the detection zone 36, and the camera pair 40B is oriented in a different direction into the detection zone 36.

The object pixel 60 that was initially identified in the “master” image 56, by way of example, is sought to be identified in the offset image 58, by way of example, by first looking at the same pixel location in the offset image 58. If a pair of adjacent pixels at that same pixel location in the offset image do not have the same intensity delta as was identified between the brightness of the object pixel 60 and an adjacent pixel in the “master” image, the software application begins moving horizontally in the offset image 58 along a horizontal line in both directions away from the original pixel location seeking to identify a pair of pixels that bear the same intensity delta. Instead of looking strictly along a line of individual pixels, the system actually looks along a band of pixels perhaps six or ten pixels in height and moving along the horizontal direction. The system looks in the horizontal direction because the two cameras 44 and 46 are horizontally spaced apart from one another, and any object pixel in one image would be horizontally spaced when seen in the other image. If the cameras 44 and 46 were vertically spaced apart, the algorithm would look in a band that extends in the vertical direction rather than in the horizontal direction.

For greater accuracy, an algorithm that is employed in the rectification routine 18 can identify a series of pixel intensities in the master image and look for the same series of pixel intensities in the other of the two images 56 and 58. For instance, the system can identify a series of four or six or eight adjacent brightness values or deltas, as opposed to merely the delta between only two adjacent brightness values, and can look for that same series of brightness values or deltas in pixels in the other of the two images 56 and 58.

As a general matter, an object pixel can be determined to exist at any pixel location where the brightness of that pixel and the brightness of an adjacent pixel are of a delta whose magnitude reaches a predetermined threshold, for example. Object pixels can exist at, for instance, locations where a change in curvature exists, where two flat non-coplanar surfaces meet, or where specific indicia exist, such as on a label where ink is applied on a different colored background wherein the threshold between the ink and the background itself provides a delta in pixel intensity.

The software thus determines that a pixel in the one image 56, which is the object pixel 60 in the one image 56, corresponds with a pixel in the other image 58, which is the same object pixel 60 in the other image 58. The locations of the two object pixels 60 in the two images 56 and 58, in terms of distances from an origin in each of the two images 56 and 58, are input into the computer system 10 which employs the stereo rectification matrix and the rectification routine 18 to output a distance along the z-axis 72 away from the camera 44 where the same object pixel 60 is situated in three dimensional space on the surface of the workpiece 8.

More specifically, the same origin 76 that is depicted in FIG. 2 is also depicted generally in FIG. 3 as being at the center of the master image 56. The offset image 58 likewise has an offset origin 78 at the same location thereon, albeit on a different image, i.e., on the offset image 58. The exemplary object pixel 60 is depicted in the image 56 as being at a vertical distance 80 along the y-axis 68 (which lies along the vertical direction in FIG. 3) away from the origin 76. Since the cameras 44 and 46 are horizontally aligned with one another, the same object pixel 60 appears in the offset image 58 at an equal vertical distance 82 along the y-axis 68. The vertical distance 80 from the origin 76 provides the coordinate along the y-axis 68 in three-dimensional space for the object pixel 60.

The object pixel 60 is depicted in the image 56 as being at a horizontal distance 84 from the origin 76, which is a distance along the x-axis 64. In the offset image 58, the same object pixel 60 appears, but at another horizontal distance 86 from an offset origin 78. The horizontal distance 84 between the origin 76 and the object pixel 60 (again, assuming the master/offset explanation scheme) in the master image 56 provides the x-axis 64 coordinate in three-dimensional space for the object pixel 60. The horizontal distance 86 is used for another purpose.

Specifically, the two horizontal distance values 84 and 86 along the x-axis 64 from the two images 56 and 58 are fed into the rectification routine 18 of the software application OpenCV. These values, along with the stereo rectification matrix, result in the outputting by the software application OpenCV of a coordinate value along the z-axis 72 with respect to the origin 76 for the object pixel 60 in three-dimensional space. The z-axis 72 extends into the plane of the image 56 of FIG. 2. As such, the object pixel 60 is given a set of coordinates in three-dimensional space at which the point of the surface of the workpiece 8, for instance, that is represented by the object pixel 60 is situated with respect to the sensor 52 of the master camera 44 as measured along the x-axis 64, the y-axis 68, and the z-axis 72.

This process is repeated for as many object pixels as can be identified, and this results in a plurality of points in three dimensional space (i.e., a point cloud) where each point corresponds with an object pixel that was identified in the master image and that corresponds with a point at a location on the exterior surface of the workpiece 8. The vertical (y-axis 68) dimension 82 with respect to the origin 76 indicates the vertical position of the pixel on the master image 56, and the horizontal (x-axis 64) dimension 84 indicates the location of the pixel in the horizontal direction on the master image 56 with respect to the origin 76. The depth of the pixel away from the camera (z-axis 72) was obtained by identifying the object pixel 60 in the other image 58 and relying upon the horizontal distances 84 and 86 between the two pixel locations and the origins 76 and 78, respectively, as well as by using the stereo rectification matrix. Each object pixel has three coordinates (X, Y, Z) with respect to the origin 76. A point cloud thus is derived for the exemplary camera pair 40.

Is understood, however, that each camera pair 40 sees only a limited portion of the workpiece 8. For instance the camera pair 40B outputs a point cloud that includes a number of three-dimensional points in space that are representative of points on the surface of the workpiece 8, for instance, from the perspective of the camera pair 40B. Advantageously, however, and as will be set forth in greater detail, the point clouds that are obtained from each camera pair 40 are virtually overlaid with one another to obtain a combined point cloud. The process of relating the point cloud from one camera pair, such as the camera pair 40B, with another camera pair, such as the camera pair 40A, is referred to as transformation. A transformation routine 18 is employed to perform such transformation.

In order to do perform the transformation operation from the camera pair 40B to the camera pair 40A, a transformation matrix is derived and may be referred to as the transformation matrix B-A. When the points in the point cloud that was generated for camera pair 40B are subjected to the transformation matrix B-A, the points in that point cloud are converted from being points from the perspective of the camera pair 40B into point in space from the perspective of the camera pair 40A. That is, the original point cloud from camera pair 40B is converted into a set of transformed points in a transformed point cloud that are in the coordinate system for the camera pair 40A and can be overlaid with the original point cloud that was obtained from the camera pair 40A. However, the transformed point cloud will be of points in space that were originally from the perspective of the camera pair 40B and thus would include portions of the workpiece 8, for instance, that would not have been visible from the camera pair 40A.

In order to derive a transformation matrix between the camera pair 40B and the camera pair 40A, the cameras 44 and 46 of the camera pair 40A and the cameras 44 and 46 of the camera pairs 40B must first go through the aforementioned calibration procedure. The camera pairs 40A and 40B are then mounted somewhat near one another but still spaced apart so that the point clouds that would be generated thereby preferably have some degree of correspondence. The two camera pairs 40A and 40B may be positioned as they would be at the periphery of the detection zone 36. A point cloud is then generated of a given object from the camera pair 40A, and another point cloud of the same object is generated from the camera pair 40B.

These two point clouds are fed into a transformation routine 18 in the exemplary form of another software package that includes an application called Point Cloud Library. This software essentially takes one point cloud and overlays or interlaces (in three dimensions) it with the other point cloud and manipulates one point cloud with respect to the other until a good correspondence is found. For instance, a good correspondence might be one in which a pair of object pixels are within a predetermined proximity of one another, such as 0.01 inch or other threshold and/or or are within a predetermined brightness threshold of one another, such as within 90% or other threshold. Such manipulations include translations in three orthogonal directions and rotations about three orthogonal axes. The software essentially comprises a large number of loops that are repeated with multiple iterations until a transformation matrix is found. The software might identify one particularly well matching pair of object pixels that were identified by the camera pairs 40A and 40B. The software might also see if these two object pixels in the two point clouds could be overlaid in order to then see if rotations with respect to that coincident pixel pair could achieve a good result. Perhaps a second pixel pair can be identified after a certain such rotation, and then further rotations would be with the two pairs of pixels being coincident.

The output from the Point Cloud Library software of the transformation routine 18 amounts to three translations along three orthogonal axes and three rotations about these same three orthogonal axes. In the depicted exemplary embodiment, the three orthogonal axes are the x-axis 64, the y-axis 68, and the z-axis 72. By further employing the transformation routine 18 and thereby subjecting each of the points in the 40B point cloud to the B-A transformation matrix, each of the points in the 40B point cloud can be transformed into point in the 40A coordinate system. This is repeated for each adjacent camera pair using similarly derived transformation matrices, i.e., H-G, G-F, F-E, E-D, D-C, C-B, etc. The coordinate system of the camera pair 40A is employed in an exemplary fashion herein in order to refer to a reference to which the point clouds that were obtained from the other camera pairs 4 are transformed in order to form a combined point cloud. It is understood that any of the camera pairs 40 could serve as the reference without departing from the spirit of the disclosed and claimed concept. The particular reference camera pair 40 that is used in any particular implementation is unimportant.

The forklift 16 can be advantageously ignored in the combined point cloud by, for example, identifying a known structure on the forklift 16 in order to determine the position and orientation of the forklift 16. The collar 32 is a structure that extends between the masts 28 and has a unique shape that may include arcuate holes and/or other arcuate portions which can be detected from above and in front by the dimensioning apparatus 4 in the images that are captured during the aforementioned dimensioning process. The dimensioning apparatus 4 could additionally or alternatively detect a wheel with lug nuts or another distinguishing shape on the forklift, but detecting the collar 32 is especially useful because the collar moves with the masts 28 and thus additionally indicates the orientation of the masts 28.

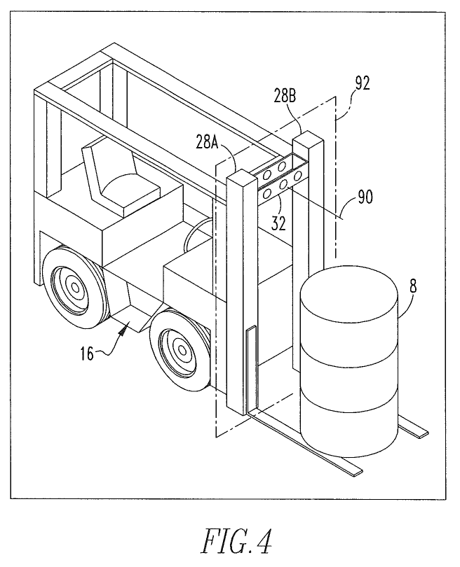

The routines 18 include information regarding the shape of the collar 32, such as might be reflected by its physical dimensions or by images thereof, and might include the shape of each type of collar used on the various forklifts that are employed in a given facility. The dimensioning apparatus 4, when it generates the combined point cloud, will identify the signature of the collar 32 among the points in the point cloud since it already knows what the collar 32 looks like. Detecting the collar 32 and specifically its detected shape will enable the dimensioning apparatus 4 to define a normal vector 90, such as is shown in FIG. 4, that extends out of the front of the collar 32.

The normal vector 90 would include an origin value (x, y, z) on the surface of the collar 32 and three orientation values (which would be three rotational values about the x-axis 64, the y-axis 68, and the z-axis 72). Since in the exemplary dimensioning apparatus 4 the various point clouds that are derived from the various camera pairs 40 are all transformed to correspond with the camera pair 40A, the aforementioned origin value and orientation values would be with respect to the origin of the master camera 44 of the camera pair 40A and its corresponding x-axis 64, y-axis 68, and z-axis 72.

The system will then define a plane 92 that is perpendicular to the normal 90 and that is situated just in front of the masts 28. All of the points behind the plane 92, i.e., those in the direction of the vehicle 16 and the forks 28 from the plane 92, will be ignored.

A plane in three dimensional space is defined by the equation Ax+By+cZ−D=0. A normal to a plane is defined as a vector with a magnitude of 1. The mathematical standard is to use the letters i, j, and k to act as the unit vector in the x,y,z directions respectively. Thus the normal to the plane in the vertical direction is defined as k−(d(f(x·y))/dx)i−(d(fx,y)/dy)j for any continuous surface. In this application, it is useful to find the normal in the vertical direction inasmuch as normals in the other directions are not as useful for determining the orientation of the masts. These calculations are done in the combined point cloud containing all of the transformed point clouds that have been transformed to the coordinate system of the camera pair 40A, in the present example. The angle of the masts 28 to vertical referred to herein as gamma can be calculated by another routine 18 by using this normal vector in the following calculation: gamma=arccos(z/sqrt(x²+y²+z²)). The angle of the masts 28 in relation to the xy plane (i.e., the floor upon which the vehicle 16 is situated) known as theta can be found by the following equation: theta=arccos(x/(sqrt(x²+y²+z²))).

During the setup phase where the collar 32 is captured and stored for reference, which is a part of the calibration phase, it is done so with theta and gamma corrected to be zero. Then, an offset plane 92 from the normal in the center of the collar 32 is calculated by one of the routines 18 that ends at the front plate of the forklift 16. This plane 92 is stored and is based upon the calculated theta and gamma during capture of the images 56 and 58 and measurement, and it is rotated into the correct position in the x,y,z coordinate system defined by the camera pairs 40. Any points that lie behind the plane 92, and which represent points on the surface of the forklift 16, are deleted from the combined point cloud. This removes from the combined point cloud any object pixels associated with the forklift 16, advantageously leaving only the object pixels associated with the workpiece 8. While this can be performed after transformation of the various point clouds from the various camera pairs 40 into the combined point cloud, it is understood that the generation of the plane 92 and the ignoring of the points that are representative of the forklift 16 can be performed for each point cloud prior to transformation, if it is desirable to do so in the particular application.

The points in the combined point cloud will then be analyzed with a loop in another routine 18 to determine whether they are on the side of the plane 92 where all of the points are to be ignored. Once all of the points on the forklift 16 itself are ignored, the remaining points will be of the workpiece 8.

It is also possible that there may be structures in the image such as structural beams and the like that the system will want to likewise ignore. The calibration operation includes capturing images that include such structures and essentially subtracting from each point cloud at each camera pair 40 the points that exist in such a calibration image. The points that are deleted, such as relating to beams, overhead lights, and the like, will be deleted from the point cloud at each camera pair 40 in order to avoid having to perform a transformation from one camera pair 40 to another of points that will be ignored anyway.

The result is a combined point cloud that includes a set of points in three dimensional space from several directions on the workpiece 8 and from which the forklift 16 has been excluded. The set of points of the combined point cloud are subjected to the Bounded Hull Algorithm that determines the smallest rectangular prism into which the workpiece 8 can fit. This algorithm is well known in the LTL industry. A weight of the workpiece 8 can also be obtained and can be combined with the smallest rectangular prism in order to determine a dimensional weight of the workpiece 8.

The advantageous dimensioning apparatus 4 and associated method take advantage of the idea that each camera pair 40 will take a pair of images 56 and 58 of the workpiece 8 which, via rectification, result in the generation of a point cloud that represents the workpiece 8 taken from that vantage point, and the transformation matrices are used to splice together the point clouds from each of the camera pairs 40 into a combined point cloud that is sufficiently comprehensive that it characterizes the entire workpiece 8, i.e., the workpiece 8 from a plurality of lateral directions and from above. Stated otherwise, the method includes capturing partial images of the workpiece 8 that are then overlaid with one another so that together they comprehensively present a single 3-D image of at least a portion of the workpiece 8.

This concept advantageously employs a plurality of cameras 44 and 46 that simultaneously take separate images of the workpiece 8 when it is situated at a single location, and the plurality of images can then be spliced together to create a single description of the workpiece 8. Also advantageously, the camera pairs 40 and the rectification process are used to generate from each camera pair 40 a portion of a combined point cloud. Furthermore, the transformation matrices between the camera pairs 40 are employed to transform each partial point cloud from each camera pair 40 to enable all of the partial point clouds to be combined together to form a single combined and comprehensive point cloud that is used for dimensioning. The point cloud typically would characterize everything above the ground, but the bottom surface of the workpiece 8 is not evaluated and is simply assumed to be flat since it does not matter whether an object on its underside is flat or rounded, it will receive the same characterization for dimensioning purposes.

The camera pairs 40 potentially could be replaced with other detection devices. For instance, an ultrasonic or infrared range finder or other detection device has the ability to capture images or other representations of the workpiece 8 from which can be generated a point cloud of the workpiece 8, and the point clouds of a plurality of such devices could be combined in the fashion set forth above. In such a situation, and depending upon the particular detection devices that are used, it may be possible to provide individual detection devices instead of providing discrete pairs of the detection devices whose outputs are subjected to a reconciliation operation. For instance, it can be understood from the foregoing that the reconciliation operation enables the dimensioning apparatus 4 to obtain coordinates along the z-axis 72 by capturing images directed along the z-axis 72 from a pair of spaced apart locations with the cameras 44 and 46. However, an ultrasonic or infrared range finder or other detection device would directly measure the distance along the z-axis 72, making unnecessary the provision of a reconciliation operation performed using data captured from a pair of spaced apart detection devices. It is not necessary to have all cameras or all ultrasonic or infrared range finders as detection devices, since either can generate a point cloud that is combined with another point cloud via transformation as set forth above.

The object pixels 60 can be based upon any of a variety of features that may occur with the surface of the workpiece 8, as mentioned above. Still alternatively, a shadow line that extends across the workpiece 8 could be used to identify one or more object pixels.

The improved dimensioning apparatus 4 thus enables improved dimensioning of the workpiece 8 since it simultaneously takes multiple images from multiple perspectives of the workpiece 8 and because it transforms the point clouds that are derived from the multiple images into a combined point cloud. The result is a high degree of accuracy with the stationary dimensioning apparatus 4 that does not require the forklift 16 to stop within the detection zone 36. Costs savings are realized from multiples aspects of the system. Other advantages will be apparent.

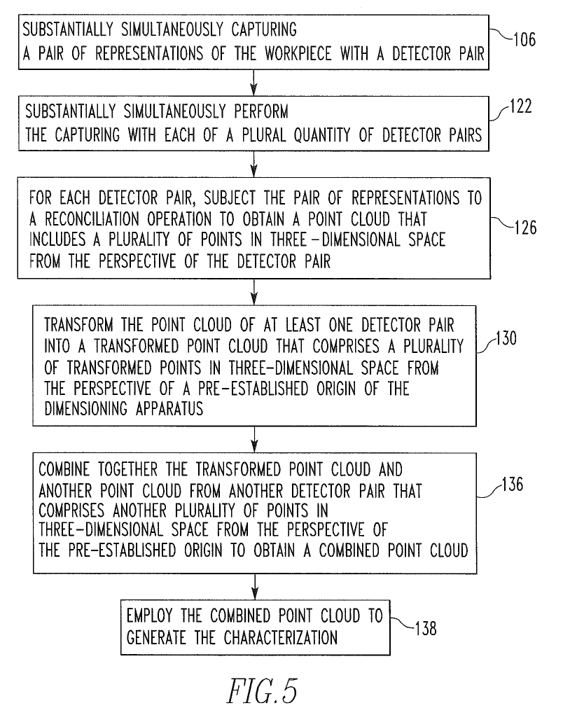

An improved flowchart depicting certain aspects of an improved method in accordance with the disclosed and claimed concept is depicted generally in FIG. 5. Processing can begin, as at 106, where the dimensioning apparatus 4 substantially simultaneously captures a pair of representations of the workpiece 8 with a sensing element pair such as a camera pair 40. It is reiterated, however, that depending upon the nature of the sensing element that is used, it may be unnecessary to actually capture a pair of representations of the workpiece 8 with a matched pair of sensing elements. As at 122, such capturing from 106 is substantially simultaneously performed with each of a plural quantity of the sensing element pairs such as the camera pairs 40. As at 126, and for each camera pair 40, the methodology further includes subjecting the pair of representations that were obtained from the camera pair 40 to a reconciliation operation to obtain a point cloud that includes a plurality of points in three-dimensional space from the perspective of a sensing element pair 40. Again, depending upon the sensing element that is employed, it may be possible to avoid the reconciliation operation if a sensing element directly measures coordinates along the z-axis 72.

Processing then continues, as at 130, with transforming the point cloud of at least one camera pair 40 into a transformed point cloud that comprises a plurality of transformed points in three-dimensional space from the perspective of a pre-established origin of the dimensioning apparatus. In the example set forth above, the origin was the camera pair 40A, although this was merely an example.

Processing then continues, as at 136, where the transformed point cloud is combined together with another point cloud from another camera pair, such as the camera pair 40A in the present example, that comprises another plurality of points in three-dimensional space from the perspective of the pre-established origin to obtain a combined point cloud. Processing then continues, as at 138, where the combined point cloud is employed to generate a characterization of the workpiece 8, such as the physical dimensions of the workpiece 8. This can be employed to generate the smallest rectangular prism into the workpiece 8 can fit, and can be combined with the weight of the workpiece 8, to obtain a dimensional weight of the workpiece 8.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A method of employing a dimensioning apparatus to generate a characterization of a workpiece that is carried on a transportation device and that is situated in a detection zone of the dimensioning apparatus, the dimensioning apparatus comprising a plurality of detection devices, the method comprising:
substantially simultaneously capturing a representation of the workpiece with each of the plurality of detection devices;
for each detection device, employing the representation therefrom to obtain a point cloud that comprises a plurality of points in three-dimensional space from the perspective of the detection device;
transforming the point cloud of at least one detection device into a transformed point cloud that comprises a plurality of transformed points in three-dimensional space from the perspective of a pre-established origin of the dimensioning apparatus that is different from the perspective of the at least one detection device;
combining together the transformed point cloud and another point cloud from another detection device that comprises another plurality of points in three-dimensional space from the perspective of the pre-established origin to obtain a combined point cloud, the at least one detection device being different from the another detection device; and
employing the combined point cloud to generate the characterization.

2. The method of claim 1 wherein the combining comprises moving one of the transformed point cloud and the another point cloud with respect to the other until a predetermined level of correspondence is achieved between the transformed point cloud and the another point cloud.

3. The method of claim 1 wherein at least some of the detection devices of the plurality of detection devices each comprise a pair of sensing elements that each have an operational direction, the operational directions of the pair of sensing elements being oriented generally parallel with one another and toward the detection zone, wherein the capturing comprises capturing substantially simultaneously with each pair of sensing elements a pair of representations of the workpiece, and further comprising subjecting each pair of representations to a reconciliation operation to obtain as the point cloud a point cloud that comprises a plurality of points in three-dimensional space from the perspective of the pair of sensing elements.

4. The method of claim 3, further comprising:
prior to the capturing, subjecting the pair of sensing elements to a calibration operation to generate a number of reconciliation values; and
employing at least some of the reconciliation values of the number of reconciliation values in the subjecting of each pair of representations to the reconciliation operation.

5. The method of claim 4 wherein at least one pair of sensing elements is a pair of cameras each having a sensor, wherein the pair of representations from the at least one pair of sensing elements is a pair of images each comprising a plurality of pixels each having a brightness value, and wherein the subjecting of the pair of representations to the reconciliation operation comprises identifying in a first image of the pair of images a first pair of adjacent pixels having a first difference in brightness values that exceeds a predetermined value.

6. The method of claim 5, further comprising:
identifying in a second image of the pair of images a second pair of adjacent pixels having a second difference in brightness values that is within a predetermined threshold of the first difference;
based at least in part upon the identifying, determining that a pixel of the first pair of pixels and another pixel of the second pair of pixels represent the same location on a surface of the workpiece; and
assigning to one of the pixel and the another pixel a set of coordinates in three dimensional space having three values, two of the three values being based upon a location of the one of the pixel and the another pixel on a sensor of the camera of the pair of cameras that captured it.

7. The method of claim 6 wherein the cameras of the pair of the cameras are horizontally spaced apart, wherein the pixel is situated at a first horizontal distance from a first origin on the sensor of the camera of the pair of cameras that captured it, and wherein the another pixel is situated at a second horizontal distance from a second origin on the sensor of the camera of the pair of cameras that captured it, and further comprising assigning the third of the three values based at least in part upon a difference between the first horizontal distance and the second horizontal distance.

8. A dimensioning apparatus having a detection zone and being structured to generate a characterization of a workpiece that is carried on a transportation device within the detection zone, the dimensioning apparatus comprising:
a plurality of detection devices each having an operational direction that is oriented generally toward the detection zone;
a computer system comprising a processor and a storage, the computer system further comprising a number of routines that are stored in the storage and that are executable on the processor to cause the dimensioning apparatus to perform operations comprising:
substantially simultaneously capturing a representation of the workpiece with each of the plurality of detection devices;
for each detection device, employing the representation therefrom to obtain a point cloud that comprises a plurality of points in three-dimensional space from the perspective of the detection device;
transforming the point cloud of at least one detection device into a transformed point cloud that comprises a plurality of transformed points in three-dimensional space from the perspective of a pre-established origin of the dimensioning apparatus that is different from the perspective of the at least one detection device;
combining together the transformed point cloud and another point cloud from another detection device that comprises another plurality of points in three-dimensional space from the perspective of the pre-established origin to obtain a combined point cloud, the at least one detection device being different from the another detection device; and
employing the combined point cloud to generate the characterization.

9. The dimensioning apparatus of claim 8 wherein the combining comprises moving one of the transformed point cloud and the another point cloud with respect to the other until a predetermined level of correspondence is achieved between the transformed point cloud and the another point cloud.

10. The dimensioning apparatus of claim 8 wherein at least some of the detection devices of the plurality of detection devices each comprise a pair of sensing elements that each have an operational direction, the operational directions of the pair of sensing elements being oriented generally parallel with one another and toward the detection zone, wherein the capturing comprises capturing substantially simultaneously with each pair of sensing elements a pair of representations of the workpiece, and wherein the operations further comprise subjecting each pair of representations to a reconciliation operation to obtain as the point cloud a point cloud that comprises a plurality of points in three-dimensional space from the perspective of the pair of sensing elements.

11. The dimensioning apparatus of claim 10 wherein the operations further comprise:
prior to the capturing, subjecting the pair of sensing elements to a calibration operation to generate a number of reconciliation values; and
employing at least some of the reconciliation values of the number of reconciliation values in the subjecting of each pair of representations to the reconciliation operation.

12. The dimensioning apparatus of claim 11 wherein at least one pair of sensing elements is a pair of cameras each having a sensor, wherein the pair of representations from the at least one pair of sensing elements is a pair of images each comprising a plurality of pixels each having a brightness value, and wherein the subjecting of the pair of representations to the reconciliation operation comprises identifying in a first image of the pair of images a first pair of adjacent pixels having a first difference in brightness values that exceeds a predetermined value.

13. The dimensioning apparatus of claim 12 wherein the operations further comprise:
identifying in a second image of the pair of images a second pair of adjacent pixels having a second difference in brightness values that is within a predetermined threshold of the first difference;
based at least in part upon the identifying, determining that a pixel of the first pair of pixels and another pixel of the second pair of pixels represent the same location on a surface of the workpiece; and
assigning to one of the pixel and the another pixel a set of coordinates in three dimensional space having three values, two of the three values being based upon a location of the one of the pixel and the another pixel on a sensor of the camera of the pair of cameras that captured it.

14. The dimensioning apparatus of claim 13 wherein the cameras of the pair of the cameras are horizontally spaced apart, wherein the pixel is situated at a first horizontal distance from a first origin on the sensor of the camera of the pair of cameras that captured it, and wherein the another pixel is situated at a second horizontal distance from a second origin on the sensor of the camera of the pair of cameras that captured it, and wherein the operations further comprise assigning the third of the three values based at least in part upon a difference between the first horizontal distance and the second horizontal distance.

15. The dimensioning apparatus of claim 10 wherein a first detection device of the plurality of detection devices is oriented such that the operational directions of its pair of sensing elements are situated in a first direction generally toward the detection zone, and wherein a second detection device of the plurality of detection devices is oriented such that the operational directions of its pair of sensing elements are situated in a second direction generally toward the detection zone, the first and second directions being different from one another.
